(19) United States
(12) Patent Application Publication
(10) Pub. No.: US 2024/0400068 A1
(43) Pub. Date: Dec. 5, 2024

(54) ENHANCING SAFETY OF A VEHICLE

(71) Applicant: Polaris Industries Inc., Medina, MN (US)

(72) Inventors: Charles A. Nelson, Wyoming, MN (US); Timothy J. Busse, Maple Grove, MN (US); Scott D. Taylor, Wyoming, MN (US)

(73) Assignee: Polaris Industries Inc., Medina, MN (US)

(21) Appl. No.: 18/676,802

(22) Filed: May 29, 2024

Related U.S. Application Data
(60) Provisional application No. 63/469,590, filed on May 30, 2023.

(51) Int. Cl. B60W 50/00; B60W 30/182; B60W 40/08; G06K 7/08

(52) U.S. Cl. CPC B60W 50/0098; B60W 30/182; B60W 40/08; G06K 7/086; B60W 2050/0083; B60W 2300/185; B60W 2420/403

(57) ABSTRACT

Systems and methods for enhancing safety of a vehicle for which a rider wears a helmet are provided. An example system include a passive tag reader and a controller in communication with the passive tag reader. The controller includes a processor and memory storing instructions that, when executed by the processor, cause the controller to perform a set of operations. The set of operations include: receiving an indication from the passive tag reader corresponding to a passive tag; evaluating the passive tag; and configuring a vehicle-limiting mode based on the evaluation.

### RELATED APPLICATIONS

The present disclosure claims the benefit of U.S. Provisional Patent Application No. 63/469,590, filed May 30, 2023, titled ENHANCING SAFETY OF A VEHICLE, docket PLR-914-30601.01P-US, the entire disclosure of which is expressly incorporated by reference herein.

### BACKGROUND

The use of helmets, seatbelts, and other safety equipment by occupants of certain vehicles, such as off-road vehicles, may provide additional protection to the occupants in the event of a mishap. There exists a need to facilitate compliance with safety equipment use that is low-cost and user-friendly. It is with respect to these and other general considerations that embodiments have been described. The embodiments described herein are not limited to solving the specific problems identified in the background.

### SUMMARY

Aspects of the present disclosure relate to methods and systems for enhancing safety of a vehicle, such as a vehicle for which a rider wears a helmet.

Some embodiments of the present disclosure provide a system for enhancing safety of a vehicle for which a rider wears a helmet. The system includes: a passive tag reader; and a controller in communication with the passive tag reader. The controller includes a processor and memory storing instructions that, when executed by the processor, cause the controller to perform a set of operations. The set of operations include: receiving an indication from the passive tag reader corresponding to a passive tag associated with the helmet of the rider; identifying a user profile based on the indication; and configuring one or more settings of the vehicle based on the user profile.

Some embodiments of the present disclosure provide a system for enhancing safety of a vehicle. The system includes: a passive tag reader; and a controller in communication with the passive tag reader. The controller includes a processor and memory storing instructions that, when executed by the processor, cause the controller to perform a set of operations. The set of operations include: enabling a vehicle-limiting mode; receiving an indication from the passive tag reader corresponding to a passive tag within the vehicle; and disabling, based on the passive tag, the vehicle-limiting mode.

Some embodiments of the present disclosure provide a vehicle. The vehicle includes a frame; a plurality of wheels operably coupled to the frame; a passive tag reader; and a controller in communication with the passive tag reader. The controller includes a processor and memory storing instructions that, when executed by the processor, cause the controller to perform a set of operations. The set of operations include: enabling a vehicle-limiting mode; receiving an indication corresponding to overriding the vehicle-limiting mode; and disabling the vehicle-limiting mode.

This summary is provided to introduce a selection of concepts in a simplified form that are further described below in the Detailed Description. This summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

Non-limiting and non-exhaustive examples are described with reference to the following Figures.

FIG. 1A illustrates an overview of an example system according to some aspects described herein.

FIG. 1B illustrates an overview of another example system according to some aspects described herein.

FIG. 2 illustrates an example vehicle, according to some aspects described herein.

FIG. 3 illustrates an example method of enhancing safety of a vehicle, according to some aspects described herein.

FIG. 4A illustrates an example method of enhancing safety of a vehicle, according to some aspects described herein.

FIG. 4B illustrates another example method of enhancing safety of a vehicle, according to some aspects described herein.

FIG. 5 illustrates an example method of enhancing safety of a vehicle, according to some aspects described herein.

FIG. 6 illustrates an overview of an example system, according to some aspects described herein.

FIG. 7 illustrates a block diagram illustrating example physical components of a computing device with which aspects of the disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

A low-cost and user-friendly helmet detection system may encourage riders of vehicle to wear helmets. For example, the helmet detection system could include a communication system, such as a Bluetooth or Bluetooth Low Energy system, cellular system, Wi-Fi system, near-field communication (NFC) system, passive radio frequency identification (RFID) system, or the like installed in a vehicle and operable with the vehicle's controls (e.g., an engine/battery management and operations system). In some examples, the helmet detection system includes a passive tag reader system installed in the vehicle and operable with the vehicle's controls. The passive tag reader system includes a passive tag installed on a user's helmet and a passive tag reader (e.g., emitter, receiver, transceiver) installed in a headrest or other portion of the vehicle in close proximity to the driver (e.g., close enough to interface with a passive tag on a helmet of the driver).

As another example, a passive tag includes a quick-response (QR) code, a barcode, or other graphical tag. In such an example, the helmet detection system includes a camera, scanner or other reader with which to scan one or more graphical tags accordingly. In examples, scanning such a graphical tag may have an associated computational performance benefit as compared to an example in which computer vision is used to determine safety equipment compliance. Thus, it will be appreciated that a passive tag according to aspects described herein may be a radio tag or a graphical tag, among other examples. Additionally, while aspects are described with respect to helmet detection, it will be appreciated that similar techniques may be used for any of a variety of other safety equipment, including, but not limited to, seatbelts, doors, jackets and/or other protective clothing, and/or nets, among other examples.

In some examples, there may be a plurality of passive tag readers installed in a vehicle (e.g., one in each head rest of a plurality of head rests included in a vehicle). As another example, a camera may additionally or alternatively be located at a front and/or rear of a passenger area. Additionally or alternatively, a passive tag reader is installed in a rollover protection structure (ROPS) of the vehicle. It will therefore be appreciated that a passive tag reader may be installed at any of a variety of locations. In certain examples, such system may use additional rider location inputs to identify whether any of the passenger seats are occupied. Rider location inputs could include the output of one or more seatbelt sensors, seat sensors, door sensors, or other applicable outputs, such as of other applicable sensors, that may be recognized by those of ordinary skill in the art. For example, if a seat sensor indicates that there is an occupant in a particular seat, that seat's passive tag reader could activate (e.g., emit a radiofrequency signal), such that a passive tag of a rider's helmet may be detected according to aspects described herein. As another example, a passive tag reader may determine whether a graphical tag is proximate to a location indicated as having an occupant. Another rider location input could include signals received by an adaptive suspension system capable of detecting vehicle loads, such that a location or distribution of one or more riders may be detected therefrom.

The passive tag reader could be shielded or otherwise have directional emission so as to remove or otherwise reduce the possibility of detecting a helmet in a storage bed of a vehicle or other location, thus instead of limiting detection to a helmet in close proximity to the passive tag reader, such as because the helmet is being worn by a driver or passenger of the vehicle. The passive tags could have unique or semi-unique identification to enable the identification of one or more user-specific settings, such as settings saved in a vehicle's management and operation systems.

Aspects described herein may include vehicle systems integration. For example, if a helmet is detected (e.g., to be within proximity of a reader coupled to or otherwise disposed within a seat or as a graphical tag in a region associated with the seat), the vehicle may operate normally. However, if the vehicle is being operated by a driver that is not wearing a helmet or there is no helmet detected for a passenger, the vehicle's management and operation system could initiate various vehicle-limiting modes. In some examples, an absence of detecting a helmet could disable the vehicle (e.g., either during operation and/or disable ignition prior to operation). In some examples, the vehicle could initiate a vehicle-limiting mode wherein a speed of the vehicle is limited (e.g., to less than 10 miles per hour). The vehicle-limiting mode could also include engine derating to reduce acceleration. It will therefore be appreciated that the vehicle-limiting mode could include any of a variety of additional or alternative limitations, such as a limitation to prevent the vehicle from being used at inclines above a predetermined threshold. Similar aspects may additionally or alternatively be applied for any of a variety of other safety equipment according to aspects described herein.

In some examples, the activation of a vehicle-limiting mode may be overridden. Because helmets are often not required by law in many instances, it may be practical to allow override of systems disclosed herein, but only by intentional, concerted effort. For example, there may be a disable switch for the disclosed system located under a panel accessible only by a tool (e.g. a screwdriver or a hex wrench). Additional and/or alternative mechanisms for overriding the disclosed systems are provided later herein.

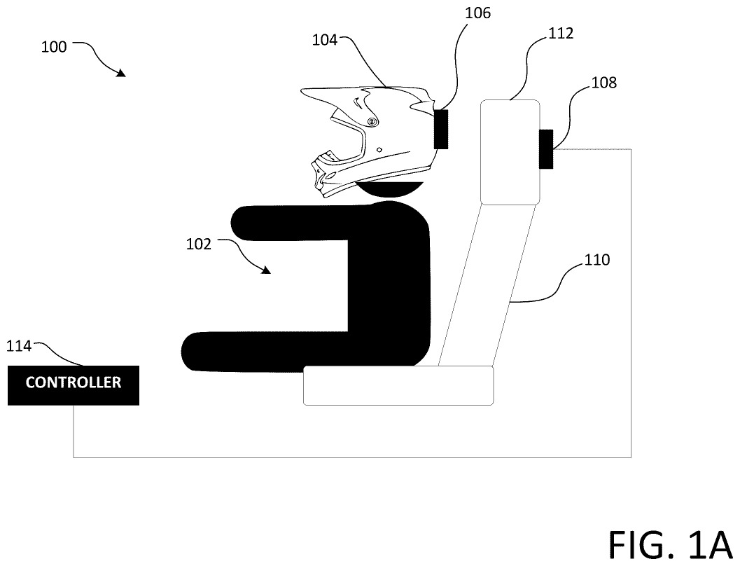

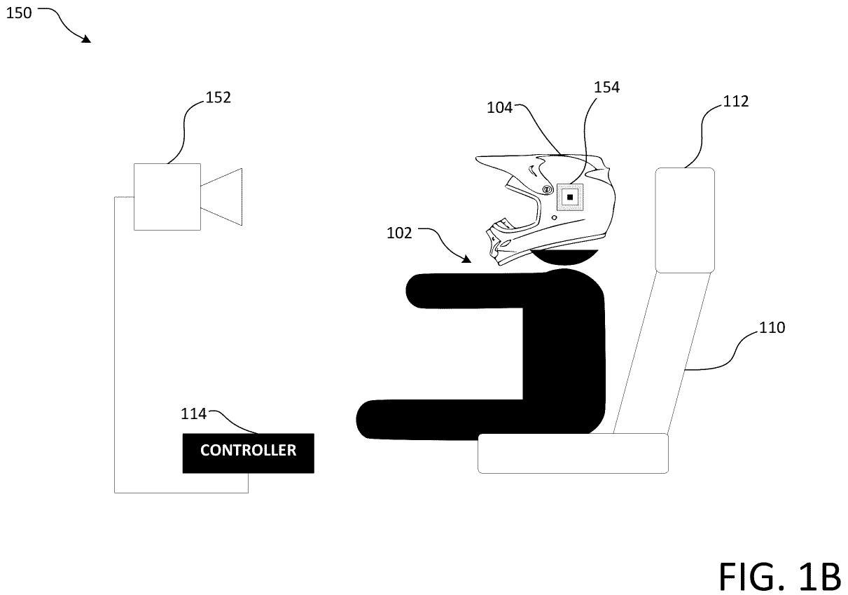

FIG. 1A illustrates an example system 100 according to some aspects described herein. The example system may be a system for enhancing safety of a vehicle, such as of a vehicle for which a rider 102 wears a helmet 104. The rider 102 may be a driver/operator or a passenger of the vehicle.

The system 100 includes a passive tag 106 and a passive tag reader 108. The passive tag 106 may be a passive radio frequency identification (RFID) tag, a near-field communication (NFC) tag, or a barcode tag, among other examples. The passive tag 106 may be a sticker, as a may be adhesively coupled to another object, or a hard tag, as may be mechanically and/or magnetically coupled to another object. The passive tag reader 108 may be an RFID tag reader, an NFC tag reader, or a barcode tag reader. Additional and/or alternative types of passive tags and passive tag readers may be recognized by those of ordinary skill in the art.

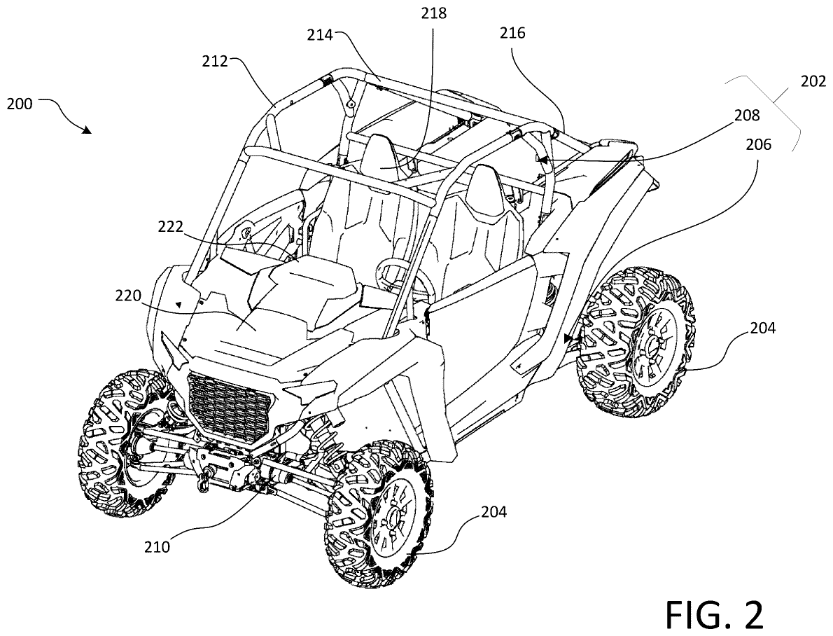

The passive tag reader 108 may be coupled to a portion of a vehicle (e.g., vehicle 200 discussed later herein with respect to FIG. 2). Specifically, the passive tag reader 108 may be coupled to a seat 110. The seat 110 may be a seat on which the operator 102 sits to operate the vehicle. The seat 110 may be a seat on which the passenger 102 sits in/on the vehicle. In some examples, the seat 110 may be an upright-seat, such as a bucket seat. In some examples, the seat 110 may be a straddle-style seat (e.g., for a motorcycle, all-terrain vehicle, jet ski, etc.).

In some examples, the system 100 includes a plurality of seats (e.g., multiple instances of the illustrated seat 110). For example, the plurality of seats 110 may be side-by-side seats, bench seats, bucket seats, or other types of seats that may be recognized by those of ordinary skill in the art. The passive tag reader 108 may be coupled to at least one of the plurality of seats 110. Additionally, or alternatively, the system 100 may include a plurality of passive tag readers 108 that are each coupled to a respective seat of the plurality of seats 110, such as in implementations where helmets (e.g., such as helmet 104) are desired to be detected for multiple occupants of a vehicle (e.g., multiple passengers, an operator and one or more passengers, etc.). The plurality of passive tag readers 108 may be positioned to interface with passive tags (such as passive tag 106) of operators and/or passengers in specific seats of the plurality of seats 110.

In some examples, the seat 110 includes a headrest 112. The passive tag reader 108 may be coupled to the headrest 112. In some examples, the passive tag reader 108 may be coupled to a side of the headrest 112 (such as to a front/rear of the headrest 112, with respect to a direction of which the operator 112 is facing). In some examples, the passive tag reader 108 may be embedded within the headrest 112. While the illustrated example shows the passive tag reader 108 coupled to a rear of the headrest 112, it should be recognized that the passive tag reader 108 may be coupled to any one of a plurality of locations along any one of a plurality of components of a vehicle (e.g., a frame, an armrest, a floor, a panel, a door, a handlebar, a console, etc.) to detect the passive tag 106.

In some examples, the headrest 112 may be manufactured with the vehicle to include the passive tag reader 108 (e.g., inside or coupled to the outside of it). In some examples, the headrest 112 (or another vehicle component), including the passive tag reader 108, may be manufactured separate from the vehicle, such that a pre-existing vehicle can be retrofit to include the headrest 112 (or the other vehicle component) that includes the passive tag reader 108. In some examples, the headrest 112 (or another vehicle component) may be manufactured with the vehicle to not include the passive tag reader 108, and then the passive tag reader 108 may be retrofit onto/into the headrest 112 (or the other vehicle component). Accordingly, in some examples, aspects of the system 100 disclosed herein, such as the passive tag reader 108, may be retrofit onto/into one or more components of a conventional vehicle, such as by strapping, screwing, or otherwise coupling the passive tag reader to the one or more components of the conventional vehicle.

In some examples, the system 100 includes a controller 114. The controller 114 may include a processor and memory storing instructions configured to implement one or more methods or processes disclosed herein. The controller 114 may be configured or otherwise programmed to control operation of an engine (e.g., for a fuel-powered vehicle or a hybrid vehicle) and/or an electric motor (e.g., for a hybrid vehicle or an electric drivetrain vehicle). In some examples, the controller 114 is configured or otherwise programmed to control operation of a battery (e.g., for a fuel-powered vehicle and/or for an electric drivetrain vehicle).

In some examples, the controller 114 is in wired communication with the passive tag reader 108, such as via a wired link, a fiber optic link, etc. For example, the passive tag reader 108 may be accessible via an Ethernet connection, via a Universal Serial Bus (USB) connection, and/or via a Controller Area Network (CAN) bus, among other examples. Additionally, or alternatively, in some examples, the controller 114 is in wireless communication with the passive tag reader 108, such as via a wireless communication network. In some examples, wireless communication network can be any suitable communication network or combination of communication networks. For example, communication network can include a Wi-Fi network (which can include one or more wireless routers, one or more switches, etc.), a peer-to-peer network (e.g., a Bluetooth or Bluetooth Low Energy network), a cellular network (e.g., a 3G network, a 4G network, a 5G network, etc., complying with any suitable standard), a wired network, etc. In some examples, communication network can be a local area network (LAN), interfaces conforming known communications standard, such as Bluetooth® standard, IEEE 802 standards (e.g., IEEE 802.11), a ZigBee® or similar specification, such as those based on the IEEE 802.15.4 standard, a wide area network (WAN), a public network (e.g., the Internet), a private or semi-private network, any other suitable type of network, or any suitable combination of networks.

Further, in some examples, the passive tag reader 108 and the controller 114 may be in direct communication, such as direct wired and/or direct wireless communication. Additionally, or alternatively, the passive tag reader 108 and the controller 114 may be in indirect communication, such as indirect wired and/or indirect wireless communication. For example, the passive tag reader 108 and/or controller 114 may be in communication with an intermediary communication device (e.g., a smartphone, tablet, wearable computing device, etc.) which then communicates with the other one of the passive tag reader 108 and/or controller 114.

While in the illustrated system 100 of FIG. 1A, the passive tag 106 is coupled to the helmet 104, it should be recognized by those of ordinary skill in the art that the passive tag 106 may be included in/on any of a variety of other garments or accessories. For example, the passive tag may otherwise be included in/on a t-shirt, hat (e.g., hard hat), jacket, necklace, vest (e.g., life vest for a watercraft), goggles, etc. Additional types of garments and/or accessories which may be worn to enhance safety for a rider of a vehicle may be recognized by those of ordinary skill in the art. Further, it will be appreciated that similar techniques may be used for any number of garments/accessories and associated passive tags.

FIG. 1B illustrates an overview of another example system 150 according to aspects of the present disclosure. Aspects of FIG. 1B are similar to FIG. 1A and are therefore not redescribed in detail below. For instance, system 150 includes passive tag reader 152 and passive tag 154. Similar to the aspects discussed above with respect to FIG. 1A, passive tag 154 is read using passive reader 152, such that controller 114 controls operation of a vehicle according to aspects described herein. As noted above, a passive tag according to aspects described herein may be used for any of a variety of additional or alternative safety equipment, including, but not limited to, seatbelts, doors, and/or nets, among other examples.

In the present example, passive tag 154 is a graphical tag, such as a QR code or a barcode, among other examples, which may thus be read or scanned by passive tag reader 152 accordingly. Similar to a radio tag, a graphical tag may encode any of a variety of information according to aspects described herein. For example, the graphical tag may encode or otherwise include a unique identifier, a region indication (e.g., indicating a region of the vehicle in which the passive tag is to be located), a rider type indication, and/or a user profile indication, among other examples. As an example, a helmet passive tag may indicate a skill level of a rider and/or include an identifier associated with a user. As another example, a seatbelt passive tag indicates a seat with which the seatbelt is associated (e.g., encoded within the graphical tag or as an identifier having an association with such a set). Thus, as compared to an instance where computer vision is used to evaluate one or more objects within an image, use of such graphical tags may permit the use of lower cost components and/or reduced utilization of computational resources, among other benefits.

In examples, the graphical tag is incorporated into a logo, pattern, or other design feature of helmet 104. Passive tag 154 may be a sticker that is adhesively coupled to helmet 154. As another example, passive tag 154 is a badge that is sewn or ironed onto a seatbelt or other piece of safety equipment. In examples, the graphical tag is emissive in infrared light and/or reflective, thereby facilitating reading passive tag 154 in low-light conditions (e.g., based on a reflection from instruments of a vehicle dash and/or using an infrared emitter/receiver). In some instances, passive tag 154 is printed, etched, or otherwise formed such that it is not apparent in visible light.

Passive tag 154 is illustrated on a side of helmet 104, though it will be appreciated that passive tag 154 may be placed at any of a variety of alternative locations in other examples. In some instances, multiple passive tags are used, such that passive tag reader 152 is able to read at least one of multiple passive tags (e.g., regardless of an orientation of helmet 154).

Passive tag reader 152 is depicted at a location at a front of a vehicle (e.g., in a dash or as a hood-mounted camera). Additionally, or alternatively, a passive tag reader may be located toward a rear of the vehicle (e.g., to capture a rear row of seats) and/or to a ROPS of the vehicle, among other examples.

In some instances, a camera of a mobile device of a user is used, as may be the case when a vehicle does not include a camera usable to read passive tags within a passenger area of the vehicle. For instance, an application of the mobile device operates the camera of the mobile device to identify one or more passive tags and thus determine safety equipment compliance accordingly. Such a determination may be made prior to vehicle operation and/or periodically during vehicle operation, among other examples. In such an example, the mobile device of the user may be mounted to a dash of the vehicle, to a front pillar of the vehicle, or to the rear of a front seat of the vehicle, among other examples.

FIG. 2 illustrates an example vehicle 200, according to some aspects provided herein. The vehicle 200 is merely an example and those of ordinary skill in the art will recognize other types of vehicles to which teachings of the present disclosure may be applied. For example, types of vehicles that may incorporate mechanisms to enhance vehicle safety provided herein may include: an all-terrain vehicle (ATV), a utility vehicle (UTV), an on-road vehicle, an off-road vehicle, a motorcycle, a snowmobile, a moped, a pontoon boat, a jet ski, a speedboat, or another type of vehicle that may be recognized by those of ordinary skill in the art.

The vehicle 200 includes a frame 202 and one or more ground engaging members 204 (e.g., wheels and tires). The frame 202 includes a lower frame 206 and an upper frame 208. The one or more ground engaging members 204 are operably coupled to the lower frame 206. The vehicle further includes a drivetrain 210 operably coupled to the lower frame 206 and drivingly connected to one or more of the ground engaging members 204. The upper frame 208 includes a front section 212, a center section 214, and a rear section 216. The front, center, and rear sections 212, 214, 216 may couple to each other and to the lower frame 206.

In examples, the drivetrain 210 is comprised of a fuel-burning engine and transmission combination, together with a driveshaft extending between the drivetrain and two of the ground engaging members 214. As another example, the drivetrain 210 could be a hybrid, fuel cell, or electric drivetrain, among other examples. The drivetrain 210, related front and rear suspension assemblies, and steering assemblies are more thoroughly described in our application Ser. No. 17/223,717, filed Apr. 6, 2021, Ser. No. 11/494,891 filed Jul. 28, 2006, and Ser. No. 11/494,890, filed Jul. 28, 2006, the subject matter of which is incorporated herein by reference.

The vehicle 200 further includes one or more seats 218. The one or more seats 218 may be similar to or the same as the seat 110 described earlier herein with respect to FIG. 1A. The one or more seats 218 may be a plurality of seats, such as side-by-side seats. In the illustrated example of FIG. 2, the one or more seats 218 are bucket seats.

The one or more seats 218 may include a passive tag reader, such as the passive tag reader 108 and/or passive tag reader 152 discussed earlier herein with respect to FIGS. 1A and 1B, respectively. Additionally, or alternatively, the passive tag reader may be coupled to the frame 202. For example, the passive tag reader may be coupled to the upper frame 208, such as at the front section 212, center section 214, and/or rear section 216. As a further example, a passive tag reader is coupled to a front of the vehicle, such as to a vehicle hood or a dash, as depicted by reference numerals 220 and 222, respectively. Examples of such a reader were discussed above with respect to FIG. 1B.

The drivetrain 210 may be in communication with a controller, such as the controller 114 discussed earlier herein with respect to FIGS. 1A and 1B. The controller may control the drivetrain 210, such as to control speed and/or acceleration of the vehicle 200. In some examples, the controller controls a battery and/or engine of the vehicle 200. In some examples, the vehicle 200 includes climate control settings, light/visibility settings, audio/entertainment settings, seat position settings, and/or suspension settings which are controlled by the controller and/or another computing device included in the vehicle 200.

Additional and/or alternative components that may be part of the vehicle 200 will be recognized by those of ordinary skill in the art, at least in light of teachings provided herein. Further, components of other types of vehicles that may incorporate mechanisms provided herein (e.g., ATVs, UTVs, on-road vehicles, off-road vehicles, motorcycles, snowmobiles, mopeds, and/or watercraft) will be recognized by those of ordinary skill in the art. For example, on a straddle-type vehicle (e.g., motorcycle, snowmobile, jet ski, etc.), the passive tag reader may be located on handlebars or a body of the vehicle.

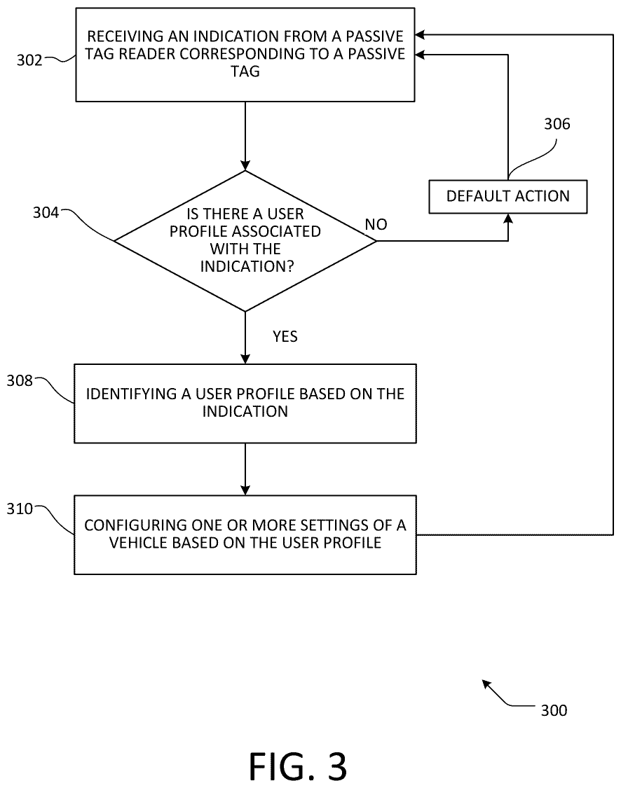

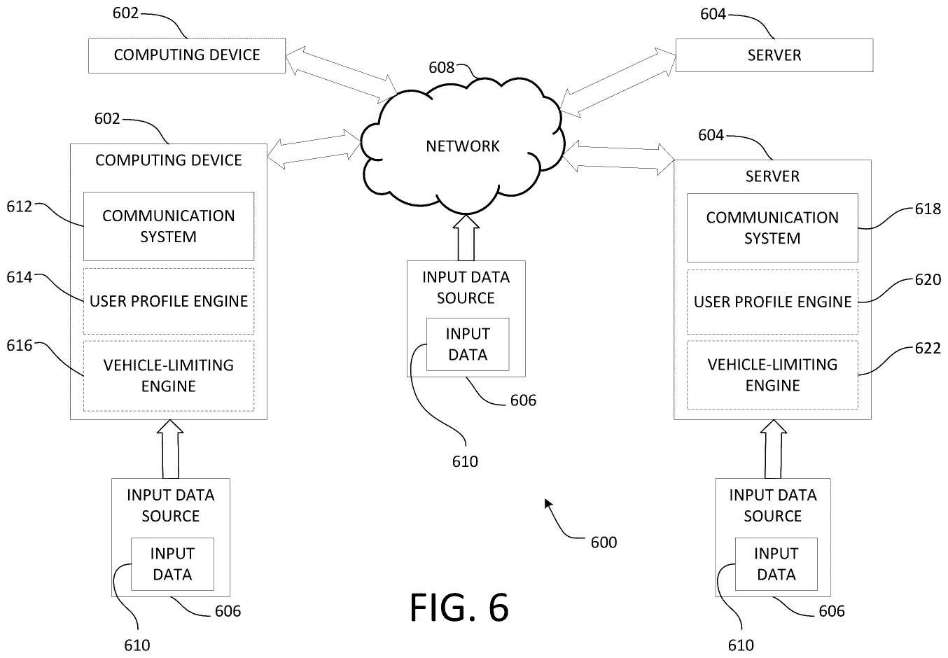

FIG. 3 illustrates an example method 300, according to some aspects described herein. The example method 300 may be a method for enhancing safety of a vehicle (e.g., vehicle 200 of FIG. 2). In examples, aspects of method 300 are performed by a device, such as computing device 602 and/or server 604, discussed below with respect to FIG. 6. Additionally, or alternatively, aspects of method 300 are performed by the controller 114, discussed above with respect to FIGS. 1A and 1B.

Method 300 begins at operation 302, wherein an indication is received from a passive tag reader. The indication may correspond to a passive tag associated with the helmet of a rider, a seatbelt of a vehicle, a door of a vehicle, and/or any of a variety of additional or alternative safety equipment. The passive tag reader may be similar or identical to the passive tag reader 108 and/or the passive tag reader 152 described earlier herein with respect to FIGS. 1A and 1B, respectively. Further, the passive tag may be similar or identical to the passive tag 106 and/or the passive tag 154 described earlier herein with respect to FIGS. 1A and 1B, respectively. In examples, the indication includes an identifier read from the passive tag. In some examples, the passive tag is writeable such that data written onto the passive tag can be obtained by a passive tag reader. The written data may include unique and/or semi-unique data that is associated with a specific individual and/or a category of individuals (e.g., skill level, subscriber level, etc.).

In some examples, prior to receiving the indication, the method 300 includes receiving a signal that corresponds to the rider (e.g., an operator and/or one or more passengers) being in the vehicle. For example, the vehicle may include a seatbelt sensor, a seat sensor, a door sensor, an ignition, a start/stop button, and/or another type of sensor/interface which provides an indication of the rider being in the vehicle. The passive tag reader may be activated in response to receiving the signal. Therefore, in some examples, the passive tag reader may be off or idle, and may only be activated once it is determined that a rider, such as an operator and/or passenger, is present in the vehicle (e.g., based on a signal from one or more vehicle sensors).

At operation 304, it is determined if there is a user profile associated with the indication. For example, the received indication may be compared against a data set that contains pairings of identifiers and user profiles to determine if a pairing exists between the received indication and a stored user profile. The data set may be stored local to a vehicle (e.g., in memory of controller 112 of FIGS. 1A and 1B) and/or remote from the vehicle. Further, the data set may be specific to an individual vehicle or apply to a fleet of vehicles.

If there is not a user profile associated with the indication, then flow branches “NO” to operation 306, where a default action is performed. For example, the indication obtained from the passive tag may include a pre-configured action that is performed at operation 306. Additionally, or alternatively, the default action may include creating a user profile, storing one or more settings, storing the received indication, associating settings with an identifier of the passive tag, etc. In some examples, a signal from the passive tag may be too weak for the passive tag reader to obtain data therefrom for determining if there is a user profile associated with the indication, thereby prompting a rider to move closer in proximity to the passive tag reader. In some examples, method 300 may comprise determining whether the indication has an associated default action, such that, in some instances, no action may be performed as a result of receiving the indication. Method 300 may terminate at operation 306. Alternatively, method 300 may return to operation 302 to provide an iterative loop of receiving an indication from a passive tag reader and determining if there is a user profile associated with the indication.

However, if it is determined that there is a user profile associated with the indication, then flow branches “YES”, wherein method 300 advances to operation 308. At operation 308, a user profile is identified based on the indication. In some examples, the user profile corresponds to a specific individual. For example, the received indication may include unique and/or semi-unique data that is associated with the specific individual. Accordingly, the received indication may be compared against a data set that contains pairings of identifiers and unique/semi-unique data to determine to which individual the received indication corresponds. The data set may be stored local to a vehicle (e.g., in memory of controller 112 of FIG. 1A) and/or remote from the vehicle.

In some examples, the indication and/or a user profile associated therewith corresponds to a skill level of operating the vehicle. For example, the skill level of operating the vehicle may include: beginner, intermediate, and advanced. Additionally, or alternatively, the user profile may correspond to a subscription level. Accordingly, settings of a vehicle may be configurable for a user based on one or more user profile categories and/or other factors (e.g., skill level, subscription level, etc.).

At operation 310, one or more settings of a vehicle are configured based on the user profile. The one or more settings may include at least one of a speed limitation or an incline limitation of the vehicle. For example, if the user profile corresponds to a beginner skill level, then the speed limitation may be set to a first value (e.g., 10 miles per hour), whereas if the user profile corresponds to an intermediate skill level, then the speed limitation may be set to a second value (e.g., higher than the first value), and whereas if the user profile corresponds to an expert skill level, then the speed limitation may be set to a third value (e.g., higher than the first and/or second value).

Similarly, if the user profile corresponds to a beginner skill level, then the incline limitation may be set to a first value (e.g., a first gradient level), whereas if the user profile corresponds to an intermediate skill level, then the incline limitation may be set to a second value (e.g., higher than the first value), and whereas if the user profile corresponds to an expert skill level, then the incline limitation may be set to a third value (e.g., higher than the first and/or second value).

Additional and/or alternative settings that may be configured will be recognized by those of ordinary skill in the art. For example, individuals may have preferences for climate control settings of a vehicle, light/visibility settings of a vehicle, audio/entertainment settings of a vehicle, seat position settings, and/or suspension settings that may be associated with their user profile and/or a category of users, such that they are configured based on an indication from a passive tag in accordance with aspects described herein.

In some examples, performance data may be collected from the vehicle. For example, the performance data may include data corresponding to speed, acceleration, fuel efficiency, battery range, incline, horsepower, torque, brake performance, whether a rider (e.g., operator and/or passenger) is wearing a helmet, etc. The performance data may be timestamped. The performance data may be transmitted (e.g., to a remote server/computing device) with an indication of the user profile. By collecting data for vehicle performance, data analysis may be performed on vehicle performance, helmet compliance, vehicle usage by user profiles, etc. Generally, aggregating vehicle statistics may help to improve vehicle safety by determining which user profiles are complying with helmet safety, when vehicles need to be serviced, and other beneficial insights which may be recognized by those of ordinary skill in the art.

Method 300 may terminate at operation 310. Alternatively, method 300 may return to operation 302 (or any other operation from method 300) to provide an iterative loop, such as of receiving an indication from a passive tag reader that corresponds to a passive tag, identifying a user profile based on the indication and enabling a setting of a vehicle that is specific to the user profile.

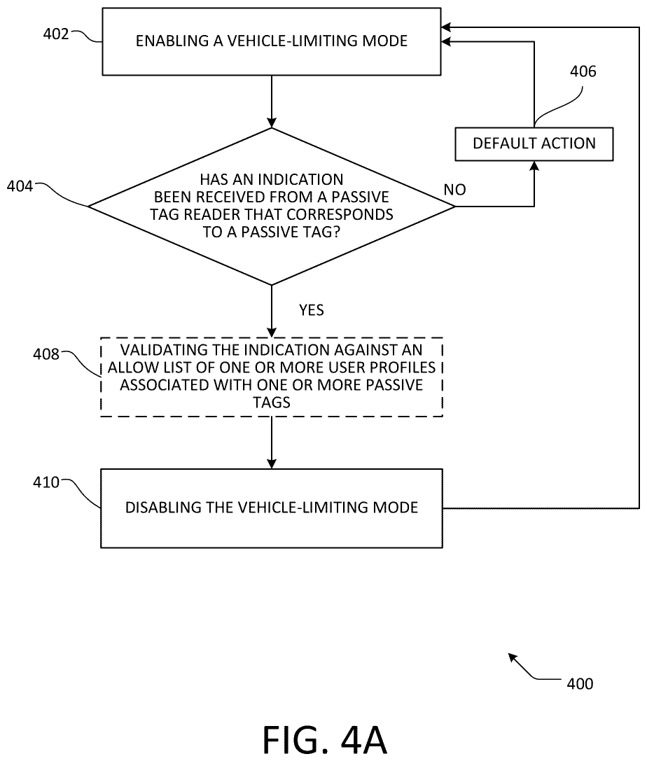

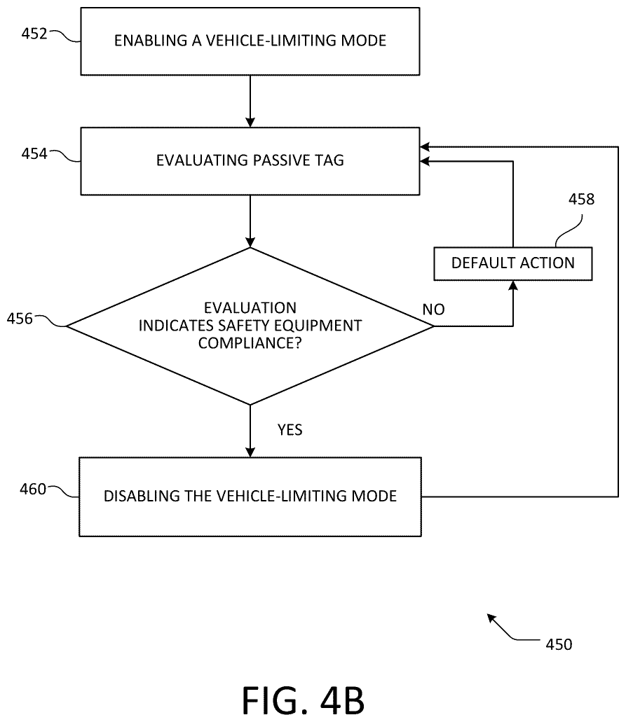

FIG. 4A illustrates an example method 400, according to some aspects described herein. The example method 400 may be a method for enhancing safety of a vehicle (e.g., vehicle 200 of FIG. 2). In examples, aspects of method 400 are performed by a device, such as computing device 602 and/or server 604, discussed below with respect to FIG. 6. Additionally, or alternatively, aspects of method 300 are performed by the controller 114, discussed above with respect to FIGS. 1A and 1B.

Method 400 begins at operation 402, wherein a vehicle-limiting mode is enabled. The vehicle-limiting mode may include one or more from the group of: setting a maximum allowable speed of the vehicle, setting a maximum allowable incline of the vehicle, derating an engine of the vehicle, and prevent the vehicle from starting. For example, the maximum allowable speed may be about 10 mph, or a value of between about 5 mph and about 15 mph, among other examples. Further, the maximum allowable incline may be about 10 degrees, or a value of between about 5 degrees and about 15 degrees, among other examples. The engine may be derated by reducing its power output or operating capacity to a percentage of its maximum rated level. Preventing the vehicle from starting may include a hard-stop, such as physically locking a button, lever, knob, switch, etc. that is configured to start the vehicle, or a soft-stop, such as software and/or an instruction in a controller (e.g., the controller 112 of FIGS. 1A and 1B) that prevents the vehicle from starting.

In some examples, the vehicle includes an engine that includes a plurality of gear settings, such as a first gear setting and a second gear setting. The engine may be in communication with the controller. Further, the first gear setting may be lower than the second gear setting. Enabling the vehicle-limiting mode at operation 402 may include limiting the engine to the first gear setting (e.g., thereby limiting the engine to a relatively lower gear). Generally, the vehicle-limiting modes limit the functionality of a vehicle, such as so that the vehicle is safer for someone who has chosen not to wear a helmet. It will be appreciated that any of a variety of additional and/or alternative limitations may be imposed on the vehicle in such a vehicle-limiting mode.

At operation 404 it is determined if an indication has been received from a passive tag reader corresponding to a passive tag associated with the helmet of a rider, a seatbelt of a vehicle, a door of a vehicle, and/or any of a variety of additional or alternative safety equipment. The passive tag reader may be similar or identical to the passive tag reader 108 and/or passive tag reader 152 described earlier herein with respect to FIGS. 1A and 1B, respectively. Further, the passive tag may be similar or identical to the passive tag 106 and/or the passive tag 154 described earlier herein with respect to FIGS. 1A and 1B, respectively. Further, examples of such aspects were discussed above with respect to method 300 in FIG. 3 and are therefore not redescribed in detail.

If an indication that corresponds to a passive tag has not been received from a passive tag reader, then flow branches “NO” to operation 406, where a default action is performed. For example, the vehicle-limiting mode may include a pre-configured action. In some examples, a signal from the passive tag may be too weak for the passive tag reader to obtain data therefrom, thereby prompting a rider to move closer in proximity to the passive tag reader. In other examples, method 400 may comprise determining whether the vehicle-limiting mode has an associated default action, such that, in some instances, no action may be performed as a result of not receiving an indication that corresponds to a passive tag from a passive tag reader. Method 400 may terminate at operation 406. Alternatively, method 400 may return to operation 402 to provide an iterative loop of checking if an indication that corresponds to a passive tag has been received from a passive tag reader, while a vehicle-limiting mode is enabled.

In some examples, at operation 404, if an indication has not been received from a passive tag reader that corresponds to a passive tag then an SOS warning signal may be enabled. For example, it may be assumed that a rider is attempting to unauthorizedly use the vehicle, such as in an emergency situation. As another example, a rider may have been in hazardous condition and lost their passive tag (e.g., a garment or accessory, such as a helmet, including their passive tag) as a result. The hazardous condition may include a vehicle accident, a vehicle rollover, and/or a fall that poses a potentially hazardous condition for one or more occupants of the vehicle. Examples of an SOS warning signal that may be enabled are discussed in further detail in application Ser. No. 17/506,204, filed Oct. 20, 2021, titled SYSTEMS AND METHODS FOR VEHICLE HAZARDOUS CONDITION DETECTION, which is incorporated herein by reference.

However, if it is determined that an indication that corresponds to a passive tag has been received from a passive tag reader, then flow branches “YES”, wherein method 400 advances to operation 408. At operation 408, the indication is validated against an allow list. The allow list may include one or more user profiles that are associated with one or more passive tags. Each user profile on the allow list may be predetermined as authorized to operate the vehicle. For example, if the vehicle is owned by a particular family, then a user profile that corresponds to each member of the family may be included on the allow list, but user profiles of people not in the family may not be included on the allow list. Further, since passive tags may be coupled to particular helmets, then the allow list may correspond to helmets owned by each member of the family, such that the helmet is a key or pass to disable the vehicle-limiting mode. It will be appreciated that similar techniques may be applied for a deny list, where an indication corresponding to an entry of the deny list fails to disable the vehicle-limiting mode, while an indication from a passive tag that is not present in the deny list disables the vehicle-limiting mode accordingly.

As another example, at a rental organization, operators may be provided with different helmets based on which vehicles they are approved to operate. Accordingly, if an operator tries to operate a vehicle for which they were not approved, then one or more aspects of the vehicle may be limited (e.g., the vehicle may not turn on, the vehicle may not exceed a certain speed, the vehicle may not operate above a certain incline, etc.).

In some examples, a particular passive tag, or an article that includes the passive tag (e.g., a helmet, t-shirt, hat, jacket, necklace, lifejacket, etc.) may be paired with a vehicle. For example, the pairing may include adding a user profile associated with the particular passive tag to an allow list.

At operation 410, the vehicle-limiting mode is disabled. In some examples, method 400 may advance directly from operation 404 to operation 410, when flow branches “YES,” such as in implementations that do not include validating the indication against an allow list of passive tags.

When the vehicle-limiting mode is disabled, the vehicle may be allowed to exceed the previously set maximum allowable speed and/or previously set maximum allowable incline. In some examples, the derating of the engine may be reversed. In some examples, the vehicle will be allowed to start, after it was previously not allowed to start. In some examples, the vehicle will be allowed to exceed a certain gear, whereas previously it may have been limited to stay at or below a certain gear. It will be appreciated that, in some examples, a vehicle-limiting mode may be only partly disabled, as may be the case when a user profile associated with an indication of a passive tag is associated with a user profile having one or more associated limitations. Such aspects may be similar to those discussed above with respect to method 300.

Method 400 may terminate at operation 410. Alternatively, method 400 may return to operation 402 (or any other operation from method 400) to provide an iterative loop, such as of enabling a vehicle-limiting mode, determining if an indication has been received from a passive tag reader that corresponds to a passive tag, and consequently disabling the vehicle-limiting mode.

FIG. 4B illustrates another example method 450 of enhancing safety of a vehicle, according to some aspects described herein. Aspects of FIG. 4B are similar to those discussed above with respect to FIG. 4A and are therefore not redescribed below.

At operation 452 a vehicle-limiting mode is enabled. Aspects of operation 452 are similar to those discussed above with respect to operation 402 discussed above with respect to method 400 of FIG. 4A. For instance, operation 452 comprises at least one or more of: setting a maximum allowable speed of the vehicle, setting a maximum allowable incline of the vehicle, derating an engine of the vehicle, and/or prevent the vehicle from starting.

Flow progresses to operation 454, where a passive tag is evaluated. In examples, operation 454 comprises evaluating a passive tag using one or more passive tag readers, examples of which were discussed above with respect to FIGS. 1A and 1B. For instance, if the passive tag is a radio tag, operation 454 may comprise determining whether a passive tag is detected (e.g., at all or above a threshold signal strength). In another example, if the passive tag is a graphical tag, the passive tag may be scanned by the passive tag reader (e.g., a camera) and associated image data may be processed to determine whether the passive tag is present with a region (e.g., associated with a rider/operator seat, with a region in which a seatbelt is fastened, or with a region corresponding to a closed door). As noted above, the tag may include an identifier associated with a given region, such that operation 454 comprises comparing an identifier obtained from the passive tag based on such an association (e.g., indicating an operator/passenger seat, an operator/passenger door, etc.). As noted above, operation 454 may additionally or alternatively comprise evaluating additional information based on the passive tag, such as a seatbelt sensor and/or a weight distribution sensor to determine whether a passive tag is expected within a given region based on other sensor data that indicates a rider is expected within the region.

In examples, evaluating the passive tag comprises processing multiple data points, for example to determine a movement associated with the passive tag and/or to determine an average location/signal strength for the passive tag, among other examples. As a further example, a passive tag may be evaluated using multiple passive tag readers (e.g., a radio and/or an image tag reader), for example to triangulate a location within the vehicle and/or to address an instance in which the tag is moving and is thus not consistently readable by the same reader. It will therefore be appreciated that any of a variety of techniques may be used to evaluate a passive tag according to aspects of the present disclosure.

Flow progresses to determination 456, where it is determined whether the evaluation indicates compliance with vehicle safety equipment. For instance, if the passive tag is determined to have a signal strength above a given threshold and/or to have an identifier associated with a region in which the passive tag is detected, it may be determined that the passive tag indicates safety equipment compliance. While method 450 is discussed with respect to a single passive tag, it will be appreciated that similar aspects may be used to evaluate multiple passive tags. In such an example, an evaluation failure of a single tag may result in an overall evaluation failure for a plurality of passive tags or, as another example, an evaluation success of a single tag may result in an overall evaluation success for the plurality of passive tags, among other examples.

If, at determination 456, an evaluation failure is determined, flow branches “NO” to operation 458, where a default action is performed. Aspects of operation 458 are similar to those discussed above with respect to operation 406 of FIG. 4A and are therefore not redescribed in detail. Flow then returns to operation 454, such that method 450 may loop between operations 454, 456, and 458 until an evaluation success is determined at determination 456.

Returning to determination 456, if an evaluation success is instead determined, flow branches “YES” to operation 460, where a vehicle-limiting mode is disabled. Aspects of operation 460 are similar to those discussed above with respect to operation 410 of FIG. 4A and are therefore not described in detail. In examples where multiple passive tags are evaluated, operation 460 may comprise disabling a vehicle-limiting mode for the vehicle overall and/or disabling functionality associated with a specific rider/operator, among other examples. As illustrated, method 450 terminates at operation 460.

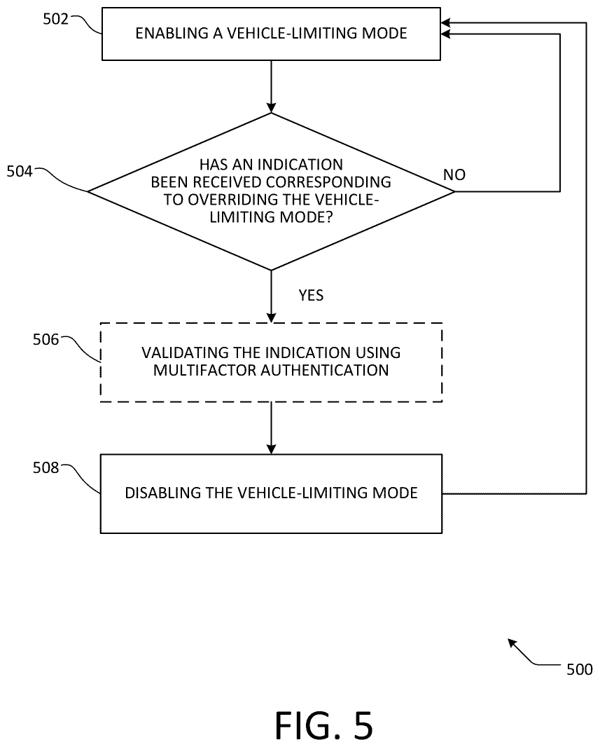

FIG. 5 illustrates an example method 500, according to some aspects described herein. The example method 500 may be a method for enhancing safety of a vehicle (e.g., vehicle 200 of FIG. 2). In examples, aspects of method 500 are performed by a device, such as computing device 602 and/or server 604, discussed below with respect to FIG. 6. Additionally, or alternatively, aspects of method 300 are performed by the controller 114, discussed above with respect to FIGS. 1A and 1B.

Method 500 begins at operation 502, wherein a vehicle-limiting mode is enabled. The vehicle-limiting mode may include one or more from the group of: setting a maximum allowable speed of the vehicle, setting a maximum allowable incline of the vehicle, derating an engine of the vehicle, and prevent the vehicle from starting. For example, the maximum allowable speed may be about 10 mph, or a value of between about 5 mph and about 15 mph, among other examples. Further, the maximum allowable incline may be about 10 degrees, or a value of between about 5 degrees and about 15 degrees, among other examples. The engine may be derated by reducing its power output or operating capacity to a percentage of its maximum rated level. Preventing the vehicle from starting may include a hard-stop, such as physically locking a button, lever, knob, switch, etc. that is configured to start the vehicle, or a soft-stop, such as software and/or an instruction in a controller (e.g., the controller 112 of FIGS. 1A and 1B) that prevents the vehicle from starting.

In some examples, the vehicle includes an engine that includes a plurality of gear settings, such as a first gear setting and a second gear setting. The engine may be in communication with the controller. Further, the first gear setting may be lower than the second gear setting. Enabling the vehicle-limiting mode at operation 502 may include limiting the engine to the first gear setting (e.g., thereby limiting the engine to a relatively lower gear). Generally, the vehicle-limiting modes limit the functionality of a vehicle, such as so that the vehicle is safer for someone who has chosen not to wear a helmet.

At operation 504, it is determined if an indication has been received that corresponds to overriding the vehicle-limiting mode. For example, the vehicle may include a user interface that is in communication with the controller. The indication that corresponds to overriding the vehicle-limiting mode may be received in response to receiving an input at the user interface. For example, the input may be turning a state of a switch (e.g., located under a panel accessible via a tool). As another example, the input may be user input provided at an in-vehicle infotainment (IVI) system. As another example, the user interface includes a button, knob, lever, microphone, and/or camera that receives a push, twist, crank, voice command, gesture, etc., among other user inputs. Additional and/or alternative types of user input and/or user interfaces that may be used in conjunction with a vehicle will be recognized by those of ordinary skill in the art. In some examples, the user interface could be restricted from inadvertent or casual access. For example, the user interface may be located behind a physical barrier (e.g., a door, panel, etc.), and/or the user interface may be protected by a passcode.

In some examples, a rider may call, text, or otherwise message a remote fleet operator to disable the vehicle-limiting mode. In such examples, the indication may be the call, text, or message requesting authorization to disable the vehicle-limiting mode. In some examples, the remote fleet operator may be able to disable the vehicle-limiting mode remotely. Additionally, or alternatively, the remote fleet operator may reply to the indication to enable the rider to disable the vehicle-limiting mode. For example, the reply may include a passcode that the rider may enter into the vehicle or a nomadic device associated with the vehicle to disable the vehicle-limiting mode.

If an indication has not been received that corresponds to overriding the vehicle-limiting mode, then flow branches “NO” to operation 502, where the vehicle limiting mode remains enabled. In some examples, a signal from the passive tag may be too weak for the passive tag reader to obtain data therefrom for determining if there is a user profile associated with the indication, thereby prompting a user to move closer in proximity to the passive tag reader. However, if it is determined that an indication has been received that corresponds to overriding the vehicle-limiting mode, then flow branches “YES”, wherein method 500 advances to operation 506. At operation 506, the indication is validated using a multifactor authentication. To add additional security in disabling a vehicle-limiting mode, a user (e.g., operator, passenger, serviceperson, etc.) may provide multiple inputs to disable the vehicle-limiting mode. For example, the user may have to turn a switch hidden underneath a panel and then also call a phone number, or provide input to a computing device (e.g., phone, tablet, wearable device, etc.), or provide input to the IVI. Additional and/or alternative mechanisms for multifactor authentication will be recognized by those of ordinary skill in the art.

In some examples, if an indication has been received that corresponds to overriding the vehicle limiting mode then an SOS warning signal may be enabled. For example, it may be assumed that a rider is attempting to unauthorizedly use the vehicle, such as in an emergency situation. Example aspects of such an SOS warning signal are discussed in further detail in application Ser. No. 17/506,204, filed Oct. 20, 2021, titled SYSTEMS AND METHODS FOR VEHICLE HAZARDOUS CONDITION DETECTION, which is incorporated herein by reference.

At operation 508, the vehicle-limiting mode is disabled. In some examples, method 500 may advance directly from operation 504 to operation 508, when flow branches “YES,” such as in implementations that do not include validating the indication using multifactor authentication.

When the vehicle-limiting mode is disabled, the vehicle may be allowed to exceed the previously set maximum allowable speed and/or previously set maximum allowable incline. In some examples, the derating of the engine may be reversed. In some examples, the vehicle will be allowed to start, after it was previously not allowed to start. In some examples, the vehicle will be allowed to exceed a certain gear, whereas previously it may have been limited to stay at or below a certain gear. It will be appreciated that, in some examples, a vehicle-limiting mode may be only partly disabled, as may be the case when a user profile associated with an indication of a passive tag is associated with a user profile having one or more associated limitations. In some examples, only some previously enabled vehicle limitations may be disabled, or a degree of the previously enabled vehicle limitations (e.g., a degree of speed, incline, etc.) may be modified. Such aspects may be similar to those discussed above with respect to method 300, as an example.

Method 500 may terminate at operation 508. Alternatively, method 500 may return to operation 502 (or any other operation from method 500) to provide an iterative loop, such as of enabling a vehicle-limiting mode, determining if an indication has been received to override the vehicle-limiting mode, and consequently disabling the vehicle-limiting mode.

FIG. 6 shows an example of a system 600, in accordance with some aspects of the disclosed subject matter. The system 600 may be a system for enhancing safety of a vehicle, such as a vehicle for which a rider wears a helmet, uses a seatbelt, and/or any of a variety of other safety equipment associated with vehicle operation. The system 600 includes one or more computing devices 602, one or more servers 604, one or more input data sources 606, and a communication network or network 608. In some examples, the computing device 602 can receive input data 610 from the input data source 606. Additionally, or alternatively, in some examples, the network 608 can receive input data 610 from the input data source 606. In some examples, the computing device 602 may be similar or identical to the controller 112 and/or the intermediary communication device described earlier herein with respect to FIGS. 1A and 1B. Accordingly, in some examples, the computing device 602 may be included in a vehicle (e.g., vehicle 200). Additionally, or alternatively, in some examples, the computing device 602 may be a nomadic device, such as a smartphone, tablet, wearable device, etc., as may be associated with a rider of the vehicle.

In some examples, computing device 602 includes a communication system 612, user profile engine or component 614, and/or a vehicle-limiting engine or component 616. In some embodiments, computing device 602 can execute at least a portion of the user profile component 614 to identify a user profile based on the input data 610. In some examples, the computing device 602 can execute at least a portion of the vehicle-limiting component 616 to enable and/or disable vehicle-limiting modes of a vehicle.

In some examples, server 604 includes a communication system 618, user profile engine or component 620, and/or a vehicle-limiting engine or component 622. In some embodiments, server 604 can execute at least a portion of the user profile component 620 to identify a user profile based on the input data 610. In some examples, the server 604 can execute at least a portion of the vehicle-limiting component 622 to enable and/or disable vehicle-limiting modes of a vehicle.

Additionally, or alternatively, in some examples, computing device 602 can communicate data received from input data source 606 to the server 604 over a communication network 608, which can execute at least a portion of the user profile component 614, 620 and/or the vehicle-limiting component 616, 622. In some examples, the user profile component 614, 620 executes one or more portions of methods/processes disclosed herein and/or recognized by those of ordinary skill in the art, in light of the present disclosure. In some examples, the vehicle-limiting component 616, 622 executes one or more portions of methods/processes disclosed herein and/or recognized by those of ordinary skill in the art, in light of the present disclosure.

In some examples, computing device 602 and/or server 604 can be any suitable computing device or combination of devices, such as a desktop computer, a vehicle computer, a mobile computing device (e.g., a laptop computer, a smartphone, a tablet computer, a wearable computer, etc.), a server computer, a virtual machine being executed by a physical computing device, a web server, etc. Further, in some examples, there may be a plurality of computing device 602 and/or a plurality of servers 604.

In some examples, input data source 606 can be any suitable source of input data (e.g., data generated from a computing device, data stored in a repository, data generated from a software application, data received by a passive tag reader, data received from a vehicle, etc.) In some examples, input source 606 can include memory storing input data (e.g., local memory of computing device 602, local memory of server 604, cloud storage, portable memory connected to computing device 602, portable memory connected to server 604, etc.). In some examples, input data source 606 can include an application configured to generate input data and provide the input data via a software interface. In some examples, input data source 606 can be local to computing device 602. In some examples, input data source 606 can be remote from computing device 602, and can communicate input data 610 to computing device 602 (and/or server 604) via a communication network (e.g., communication network 608). In some examples, the input data source 606 may include multiple sources of input data.

In some examples, the input data 610 may include data retrievable from a passive tag (e.g., an RFID tag, NFC tag, barcode tag, etc.). In some examples, input data 610 may include user profile data retrievable from a remote and/or local data store (e.g., of server 604 or computing device 602, respectively). In some examples, the input data 610 may include vehicle information retrievable from a vehicle controller, sensors of a vehicle (e.g., seatbelt sensor, door sensor, seat sensor, etc.), and/or components of a vehicle (e.g., engine, battery, etc.).

In some examples, communication network 608 can be any suitable communication network or combination of communication networks. For example, communication network 608 can include a Wi-Fi network (which can include one or more wireless routers, one or more switches, etc.), a peer-to-peer network (e.g., a Bluetooth or Bluetooth Low Energy network), a cellular network (e.g., a 3G network, a 4G network, a 5G network, etc., complying with any suitable standard), a wired network, a Controller Area Network (CAN), etc. In some examples, communication network 608 can be a local area network (LAN), interfaces conforming known communications standard, such as Bluetooth® standard, IEEE 802 standards (e.g., IEEE 802.11), a ZigBee® or similar specification, such as those based on the IEEE 802.15.4 standard, a wide area network (WAN), a public network (e.g., the Internet), a private or semi-private network (e.g., a corporate or university intranet), any other suitable type of network, or any suitable combination of networks. In some examples, communication links (arrows) shown in FIG. 6 can each be any suitable communications link or combination of communication links, such as wired links, fiber optics links, Wi-Fi links, Bluetooth® links, cellular links, satellite links, etc.

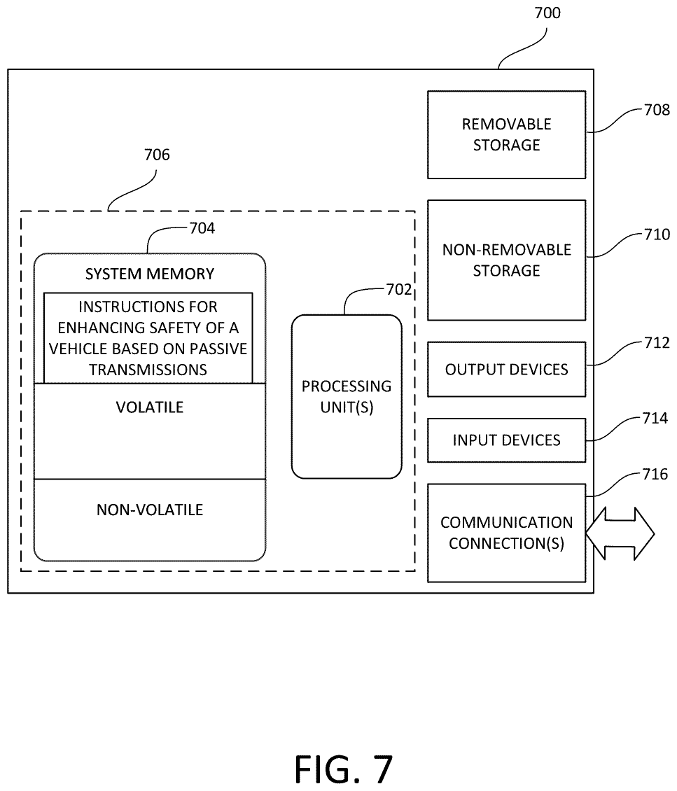

FIG. 7 illustrates a simplified block diagram of a device with which aspects of the present disclosure may be practiced in accordance with aspects of the present disclosure. The device may be a mobile computing device, for example. One or more of the present embodiments may be implemented in an operating environment 700. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smartphones, network PCs, minicomputers, mainframe computers, distributed computing environments that include any of the above systems or devices, and the like.

In its most basic configuration, the operating environment 700 typically includes at least one processing unit 702 and memory 704. Depending on the exact configuration and type of computing device, memory 704 (e.g., instructions for one or more aspects disclosed herein, such as one or more aspects of methods/processes 300, 400, and/or 500, described with respect to FIGS. 3, 4, and 5, respectively) may be volatile (such as RAM), non-volatile (such as ROM, flash memory, etc.), or some combination of the two. This most basic configuration is illustrated in FIG. 7 by dashed line 706. Further, the operating environment 700 may also include storage devices (removable, 708, and/or non-removable, 710) including, but not limited to, magnetic or optical disks or tape. Similarly, the operating environment 700 may also have input device(s) 714 such as remote controller, keyboard, mouse, pen, voice input, on-board sensors, etc. and/or output device(s) 712 such as a display, speakers, printer, motors, etc. Also included in the environment may be one or more communication connections 716, such as LAN, WAN, a near-field communications network, a cellular broadband network, point to point, etc.

Operating environment 700 typically includes at least some form of computer readable media. Computer readable media can be any available media that can be accessed by the at least one processing unit 702 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. Computer storage media does not include communication media. Computer storage media does not include a carrier wave or other propagated or modulated data signal.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The operating environment 700 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.
Clause 1. A system for enhancing safety of a vehicle for which a rider wears a helmet, the system comprising: a passive tag reader; and a controller in communication with the passive tag reader, the controller comprising a processor and memory storing instructions that, when executed by the processor, cause the controller to perform a set of operations, the set of operations comprising: receiving an indication from the passive tag reader corresponding to a passive tag associated with the helmet of the rider; identifying a user profile based on the indication; and configuring one or more settings of the vehicle based on the user profile.
Clause 2. The system of any of the clauses herein, wherein the one or more settings include at least one of a speed limitation or an incline limitation of the vehicle.
Clause 3. The system of any of the clauses herein, wherein the set of operations further comprises, prior to receiving the indication: receiving a signal corresponding to the rider being in the vehicle; and activating the passive tag reader, in response to receiving the signal.
Clause 4. The system of any of the clauses herein, wherein the user profile corresponds to one of a specific individual or a skill level of operating the vehicle.
Clause 5. The system of claim any of the clauses herein, further comprising: the passive tag; and the helmet, wherein the passive tag is coupled to the helmet.
Clause 6. The system of any of the clauses herein, further comprising: a headrest, wherein the passive tag reader is coupled to the headrest.
Clause 7. The system of any of the clauses herein, wherein the controller is in wireless communication with the passive tag reader.
Clause 8. The system of any of the clauses herein, wherein the set of operations further comprise: collecting performance data of the vehicle; and transmitting the performance data with an indication of the user profile.
Clause 9. A system for enhancing safety of a vehicle, the system comprising: a passive tag reader; and a controller in communication with the passive tag reader, the controller comprising a processor and memory storing instructions that, when executed by the processor, cause the controller to perform a set of operations, the set of operations comprising: enabling a vehicle-limiting mode; receiving an indication from the passive tag reader corresponding to a passive tag within the vehicle; and disabling, based on the passive tag, the vehicle-limiting mode.
Clause 10. The system of any of the clauses herein, wherein the vehicle-limiting mode comprises one or more from the group of: setting a maximum allowable speed of the vehicle, setting a maximum allowable incline of the vehicle, derating an engine of the vehicle, and preventing the vehicle from starting.
Clause 11. The system of any of the clauses herein, further comprising: an engine comprising at least a first gear setting and a second gear setting, the engine being in communication with the controller, wherein enabling the vehicle-limiting mode comprises limiting the engine to the first gear setting, the first gear setting being lower than the second gear setting.
Clause 12. The system of any of the clauses herein, wherein the passive tag is associated with at least one of: a helmet of a rider, a seatbelt of the vehicle, a door of the vehicle, or a net of the vehicle.
Clause 13. The system of any of the clauses herein, further comprising: a helmet, wherein the passive tag is coupled to the helmet; and a headrest, wherein the passive tag reader is coupled to the headrest.
Clause 14. The system of any of the clauses herein, wherein: the passive tag is a graphical tag; the passive tag reader comprises a camera; the indication comprises an identifier encoded by the graphical tag; and the vehicle-limiting mode is disabled in response to detecting the passive tag in a region indicated by the encoded identifier.
Clause 15. A vehicle comprising: a frame; a plurality of wheels operably coupled to the frame; a passive tag reader; and a controller in communication with the passive tag reader, the controller comprising a processor and memory storing instructions that, when executed by the processor, cause the controller to perform a set of operations, the set of operations comprising: enabling a vehicle-limiting mode; receiving an indication corresponding to overriding the vehicle-limiting mode; and disabling the vehicle-limiting mode.
Clause 16. The vehicle of any of the clauses herein, wherein the vehicle further comprises a user interface in communication with the controller, and wherein the indication corresponding to overriding the vehicle-limiting mode is received in response to receiving an input at the user interface.
Clause 17. The vehicle of any of the clauses herein, wherein the frame includes a lower frame and an upper frame, the upper frame comprising a front section, a center section, and a rear section, the front, center, and rear sections being coupled to each other and to the lower frame.
Clause 18. The vehicle of any of the clauses herein, wherein the vehicle-limiting mode comprises one or more from the group of: setting a maximum allowable speed of the vehicle, setting a maximum allowable incline of the vehicle, derating an engine of the vehicle, and preventing the vehicle from starting.
Clause 19. The vehicle of any of the clauses herein, wherein the vehicle further comprises one or more seats, and wherein the passive tag reader is coupled to at least one of the one or more seats.
Clause 20. The vehicle of any of the clauses herein, wherein the controller is in wireless communication with the passive tag reader.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system for enhancing safety of a vehicle for which a rider wears a helmet, the system comprising:
a passive tag reader; and
a controller in communication with the passive tag reader, the controller comprising a processor and memory storing instructions that, when executed by the processor, cause the controller to perform a set of operations, the set of operations comprising:
receiving an indication from the passive tag reader corresponding to a passive tag associated with the helmet of the rider;
identifying a user profile based on the indication; and
configuring one or more settings of the vehicle based on the user profile.

2. The system of claim 1, wherein the one or more settings include at least one of a speed limitation or an incline limitation of the vehicle.

3. The system of claim 1, wherein the set of operations further comprises, prior to receiving the indication:
receiving a signal corresponding to the rider being in the vehicle; and
activating the passive tag reader, in response to receiving the signal.

4. The system of claim 1, wherein the user profile corresponds to one of a specific individual or a skill level of operating the vehicle.

5. The system of claim 1, further comprising:
the passive tag; and
the helmet, wherein the passive tag is coupled to the helmet.

6. The system of claim 5, further comprising:
a headrest, wherein the passive tag reader is coupled to the headrest.

7. The system of claim 1, wherein the controller is in wireless communication with the passive tag reader.

8. The system of claim 1, wherein the set of operations further comprise:
collecting performance data of the vehicle; and
transmitting the performance data with an indication of the user profile.

9. A system for enhancing safety of a vehicle, the system comprising:
a passive tag reader; and
a controller in communication with the passive tag reader, the controller comprising a processor and memory storing instructions that, when executed by the processor, cause the controller to perform a set of operations, the set of operations comprising:
enabling a vehicle-limiting mode;
receiving an indication from the passive tag reader corresponding to a passive tag within the vehicle; and
disabling, based on the passive tag, the vehicle-limiting mode.

10. The system of claim 9, wherein the vehicle-limiting mode comprises one or more from the group of: setting a maximum allowable speed of the vehicle, setting a maximum allowable incline of the vehicle, derating an engine of the vehicle, and preventing the vehicle from starting.

11. The system of claim 9, further comprising:
an engine comprising at least a first gear setting and a second gear setting, the engine being in communication with the controller,
wherein enabling the vehicle-limiting mode comprises limiting the engine to the first gear setting, the first gear setting being lower than the second gear setting.

12. The system of claim 9, wherein the passive tag is associated with at least one of: a helmet of a rider, a seatbelt of the vehicle, a door of the vehicle, or a net of the vehicle.

13. The system of claim 9, further comprising:
a helmet, wherein the passive tag is coupled to the helmet; and
a headrest, wherein the passive tag reader is coupled to the headrest.

14. The system of claim 9, wherein:
the passive tag is a graphical tag;
the passive tag reader comprises a camera;
the indication comprises an identifier encoded by the graphical tag; and
the vehicle-limiting mode is disabled in response to detecting the passive tag in a region indicated by the encoded identifier.

15. A vehicle comprising:
a frame;
a plurality of wheels operably coupled to the frame;
a passive tag reader; and
a controller in communication with the passive tag reader, the controller comprising a processor and memory storing instructions that, when executed by the processor, cause the controller to perform a set of operations, the set of operations comprising:
enabling a vehicle-limiting mode;
receiving an indication corresponding to overriding the vehicle-limiting mode; and
disabling the vehicle-limiting mode.

16. The vehicle of claim 15, wherein the vehicle further comprises a user interface in communication with the controller, and wherein the indication corresponding to overriding the vehicle-limiting mode is received in response to receiving an input at the user interface.

17. The vehicle of claim 15, wherein the frame includes a lower frame and an upper frame, the upper frame comprising a front section, a center section, and a rear section, the front, center, and rear sections being coupled to each other and to the lower frame.

18. The vehicle of claim 15, wherein the vehicle-limiting mode comprises one or more from the group of: setting a maximum allowable speed of the vehicle, setting a maximum allowable incline of the vehicle, derating an engine of the vehicle, and preventing the vehicle from starting.

19. The vehicle of claim 15, wherein the vehicle further comprises one or more seats, and wherein the passive tag reader is coupled to at least one of the one or more seats.

20. The vehicle of claim 15, wherein the controller is in wireless communication with the passive tag reader.
